(19) United States
(12) Patent Application Publication
(10) Pub. No.: US 2017/0203448 A1
(43) Pub. Date: Jul. 20, 2017

(54) SAFETY UTILITY KNIFE ASSEMBLIES, AND COMPONENTS FOR USE WITHIN SAFETY UTILITY KNIFES

(71) Applicant: KLEVER KUTTER LLC, Grand Haven, MI (US)

(72) Inventors: Matthew J. Jacobs, Grand Haven, MI (US); Randolph Scott Presley, Grand Haven, MI (US); Gary Edward Holt, Holland, MI (US)

(21) Appl. No.: 14/996,342

(22) Filed: Jan. 15, 2016

(51) Int. Cl. B26B 5/00; B26B 9/00

(52) U.S. Cl. CPC B26B 5/00; B26B 9/00

(57) ABSTRACT

The present disclosure relates to a safety utility knife including a blade carrier that is repositionable between a safety orientation, an intermediate orientation and a cutting orientation via an actuator that is interconnected with the blade carrier via a hingable link. Once the blade carrier is repositioned to the cutting orientation, the blade carrier is automatically returned to the safety orientation anytime a cutting action is discontinued.

### RELATED APPLICATIONS

This application is related to U.S. patent application Ser. No. 13/866,074, which was filed on May 3, 2013, the entire disclosure of which is incorporated herein by reference.

### FIELD OF THE INVENTION

The present disclosure relates to utility knives. More specifically, the present disclosure relates to safety utility knifes which limit user exposure to associated cutting edges.

### BACKGROUND

Utility knives are used for a host of purposes, such as opening cardboard boxes, cutting sheet material, cutting web material, opening packages, etc. Injuries to the users of utility knifes are all too common due to inadvertent contact with the cutting edges of the associated blades. Injuries may be particularly severe when the given utility knife includes a razor blade.

Inadvertent contact with the cutting edges of blades can be equally common during blade removal, insertion and handling. Inadvertent contact with the cutting edges is particularly problematic when a user is removing or inserting a double edge razor blade into an associated utility knife.

Utility knifes that limit user exposure to associated cutting edges are desirable.

### SUMMARY

A safety utility knife may include a blade carrier pivotally connected to an actuator via a hinged link, wherein the blade carrier is pivotable between a safety orientation, an intermediate orientation, and a cutting orientation, wherein the actuator is pivotable between a non-actuating orientation and an actuating orientation, and wherein the hinged link includes a blade carrier link portion hingingly connected to an actuator link portion. When the actuator is in the non-actuating orientation and the blade carrier may be in the safety orientation, the blade carrier link portion is not hinged with respect to the actuator link portion. When a user reorients the actuator from the non-actuating orientation to the actuating orientation, the blade carrier may be reoriented from the safety orientation to the intermediate orientation, and the blade carrier link portion is not hinged with respect to the actuator link portion. When the blade carrier is oriented in the intermediate orientation and the user initiates a cutting action, the blade carrier may be reoriented from the intermediate orientation to the cutting orientation and the blade carrier hinges the blade carrier link portion with respect to the actuator link portion. When the blade carrier is oriented in the cutting orientation and the actuator may be oriented in the actuating orientation, and the cutting action is discontinued, the blade carrier link portion is further hinged with respect to the actuator link portion and the blade carrier is reoriented to the safety orientation. When the blade carrier is oriented in the cutting orientation and the actuator is oriented in the non-actuating orientation, and the cutting action is discontinued, the blade carrier link portion may be unhinged with respect to the actuator link portion and the blade carrier is reoriented to the safety orientation.

In another embodiment, a safety utility knife may include a blade carrier repositionable between a safety orientation, an intermediate orientation, and a cutting orientation. The safety utility knife may also include an actuator that may be repositionable between a non-actuating orientation and an actuating orientation. The safety utility knife may further include a hinged link interconnected between the blade carrier and the actuator. The hinged link may include a blade carrier link portion hingingly connected to an actuator link portion.

In a further embodiment, a safety utility knife may include a blade carrier repositionable between a safety orientation, an intermediate orientation, and a cutting orientation. The safety utility knife may also include a blade carrier biasing spring that may bias the blade carrier to the safety orientation. The safety utility knife may further include an actuator that may be repositionable between a non-actuating orientation and an actuating orientation. The safety utility knife may yet further include an actuator biasing spring that may bias the actuator to the non-actuating orientation. The safety utility knife may also include a hinged link, interconnected between the blade carrier and the actuator, that may include a blade carrier link portion hingingly connected to an actuator link portion.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE FIGURES

FIGS. 1A-1C depict an example safety utility knife assembly;

FIGS. 2A-2D depict internal components of the example safety utility knife of FIGS. 1A-1C;

FIG. 3 depicts an exploded view of the components of the example safety utility knife of FIGS. 1A-1C; and

FIGS. 4A-4C depict another example safety utility knife assembly.

### DETAILED DESCRIPTION

The safety utility knife assemblies of the present disclosure incorporate various features that limit user exposure to associated cutting edges. The figures depict exemplary embodiments of safety utility knife assemblies. One skilled in the art will readily recognize from the corresponding written description that alternative embodiments of the structures, that are illustrated herein, may be employed without departing from the principles described.

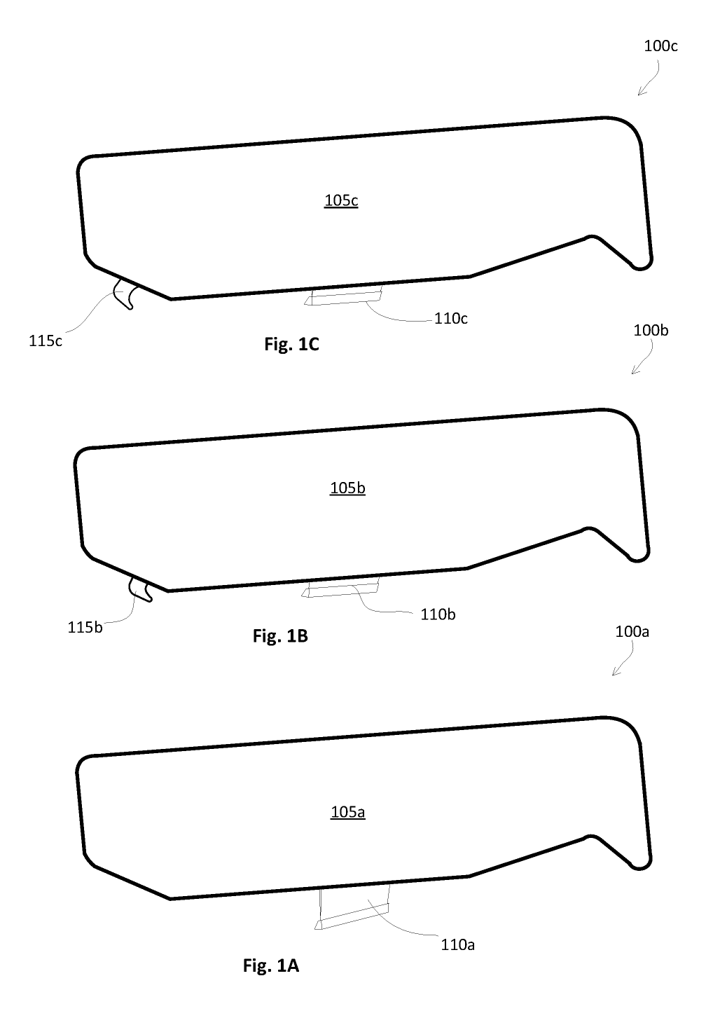

Turning to FIGS. 1A-1C, a safety utility knife 100a, 100b, 100c may include a safety utility knife body 105a, 105b, 105c; an actuator 110a, 110b, 110c; and a blade 115b, 115c. As described herein, the safety utility knife body 105a, 105b, 105c may function as a user handle, an enclosure, and a mounting structure for various components incorporated within the safety utility knife 100a, 100b, 100c.

As illustrated in FIG. 1A, prior to a user actuating the actuator 110a, an associated blade (not shown in FIG. 1A) may be retracted within the safety utility knife body 105a (i.e., the blade is oriented in a safety orientation). Accordingly, a user of the safety utility knife 100a may not be exposed to any sharp edges (e.g., a cutting edge of a blade) prior to actuating the actuator 110a.

As illustrated in FIG. 1B, once a user actuates the actuator 110b (e.g., by moving the actuator 110b toward the safety utility knife body 105b), the blade 115b may be oriented into an intermediate orientation. When the blade 115b is oriented in the intermediate orientation, a user may have limited exposure to a sharp edge (e.g., a cutting edge of a blade).

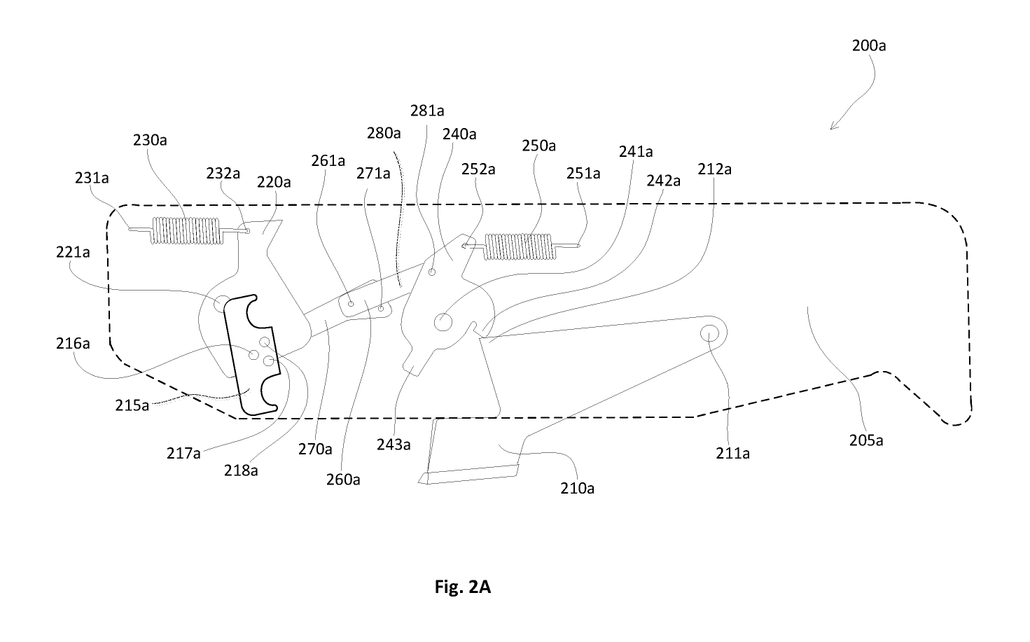

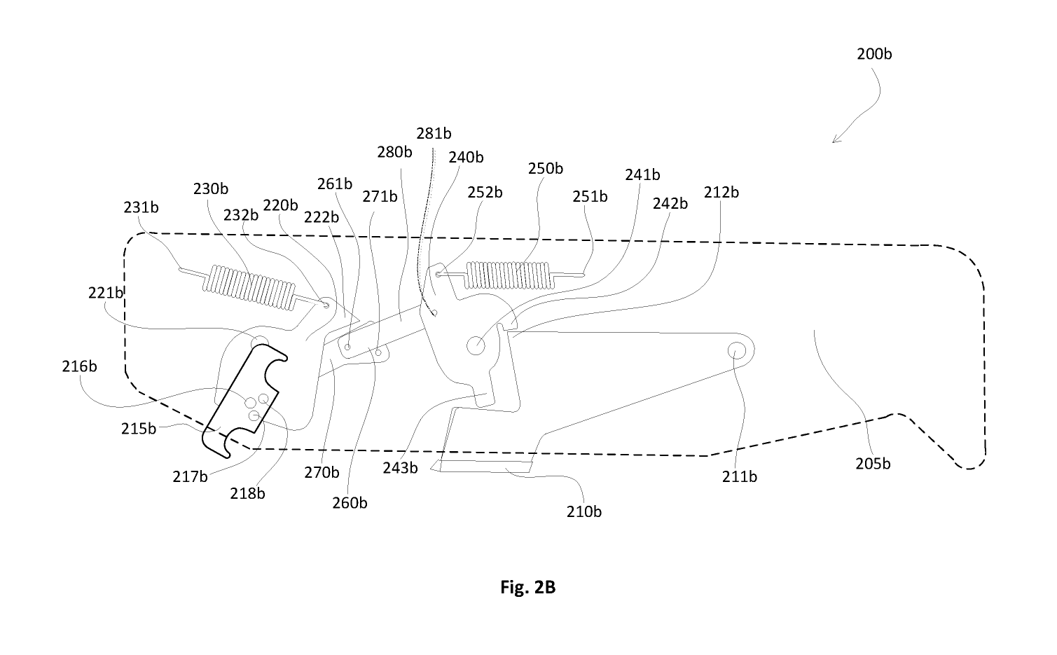

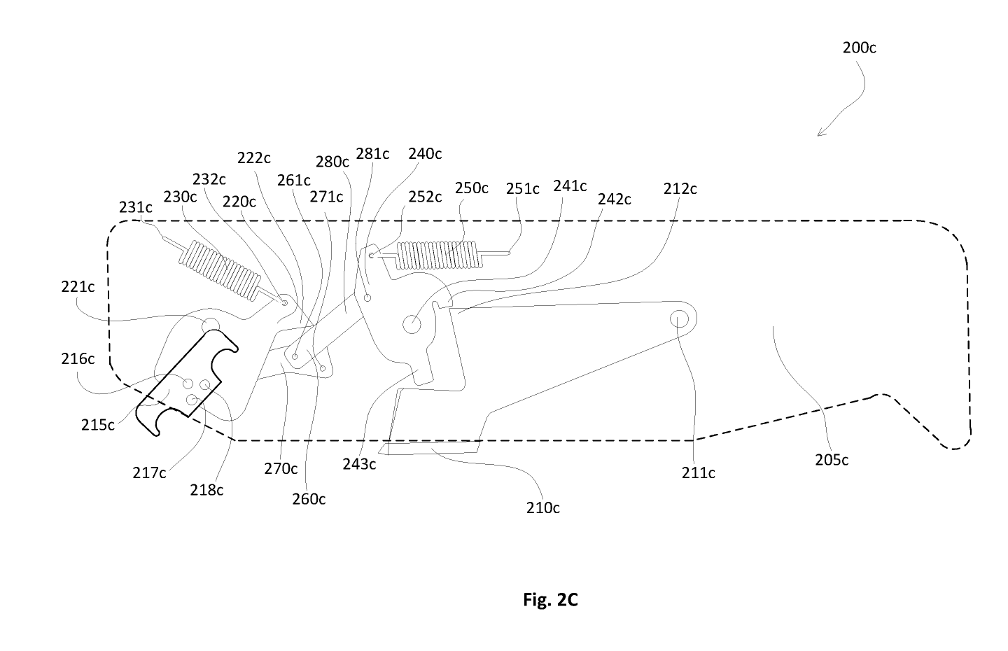

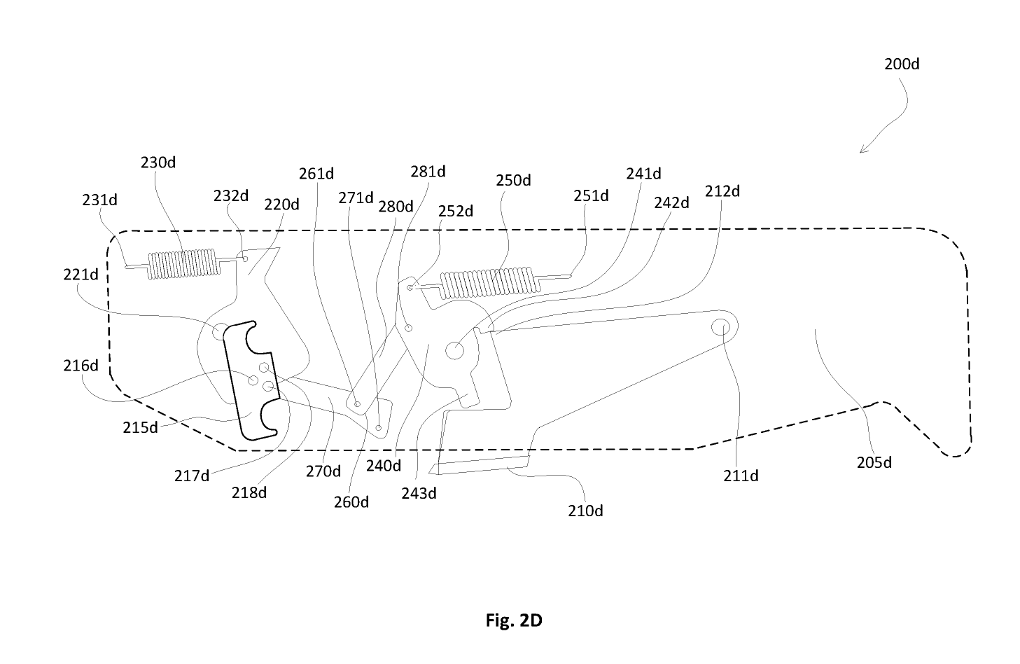

As illustrated in FIG. 1C, once the blade 115b is oriented in the intermediate position as shown in FIG. 1B, the blade 115c may be reoriented into a cutting position in response to, for example, a user bringing the blade 115b in contact with an associated material to be cut. As described herein, once the blade 115c is oriented in the cutting position as illustrated in FIG. 1C and the blade 115c loses contact with what every caused the blade 115c to be oriented in the cutting orientation (e.g., contact with the material to be cut), the blade 115c may be automatically reoriented to the safety orientation as illustrated, for example, in FIG. 1A. Notably, as described herein, the blade 115c may be automatically reoriented to the safety orientation irrespective of the orientation of the actuator 110c (i.e., automatic reorientation of the blade 115c to the safety position is describe in detail with respect to FIG. 2D). While the blade 115b, 115c is depicted in FIGS. 1B and 1C as including an associated cutting edge in a concave configuration, the blade 115b, 115c may trapezoidal shape as described in commonly assigned U.S. patent application Ser. No. 13/866,074, or the blade 115b, 115c may include other known shapes.

With reference to FIG. 2A, a safety utility knife 200a may include a body 205a housing a blade carrier 220a interconnected with an actuator 240a via a hinged linked 260a. The safety utility knife 200a may be similar to, for example, the safety utility knife 110a of FIG. 1A. In any event, the actuator 240a may be pivotally attached to the body 205a via an actuator pivot 241a. The hinged link 260a may include a blade carrier link portion 270a hingeably connected to an actuator link portion 280a via a hinged link pivot 261a. The blade carrier link portion 270a may be pivotally attached to the blade carrier 220a via a blade carrier link pivot 216a. The blade carrier link portion 270a may include a hinge stop 271a which may be, for example, configured to limit (or prevent) hinging of the hinged link in a predetermined direction. The actuator link portion 280a may be pivotally attached to the actuator 240a via an actuator link pivot 281a.

The safety utility knife 200a may include a blade 215a replaceably secured to the blade carrier 220a via, for example, pins/holes 217a, 218a. Alternatively, the blade 215a and the blade carrier 220a may be integrated in a single component. In any event, the blade 215a may be constructed as disclosed in commonly assigned U.S. patent application Ser. No. 13/866,074, or the blade 215a may be constructed in accordance with other known designs.

The blade carrier 220a may be pivotally attached to the body 205a via a blade carrier pivot 221a. The blade carrier 220a may be biased toward the safety orientation as illustrated in FIG. 2A via a blade carrier biasing spring 230a. The blade carrier biasing spring 230a may be attached to the body 215a via a first blade carrier biasing spring attachment 231a, and may be attached to the blade carrier 220a via a second blade carrier biasing spring attachment 232a.

The safety utility knife 200a may include a lever 210a pivotally attached to the body 215a via a lever pivot 211a. A lever activating portion 212a may cooperate with an actuator portion 242a to pivotally reorient the actuator 220a about an actuator pivot 242a in response to, for example, a user pressing of the lever 210a. Alternatively, the lever 210a and the actuator 240a may be integrated into a single actuator structure. The actuator 220a and the lever 210a may be biased in a non-actuating orientation, as illustrated in FIG. 2A, via an actuator biasing spring 250a. The actuator biasing spring 250a may be attached to the actuator 240a via a first actuator biasing spring attachment 251a, and may be attached to the body 215a a second actuator biasing spring attachment 252a. The actuator 240a may include an actuator stop 243a configured to limit rotation of the actuator 240a.

Turning to FIG. 2B, a safety utility knife 200b may include a body 205b housing a blade carrier 220b interconnected with an actuator 240b via a hinged linked 260b. The safety utility knife 200b may be similar to, for example, the safety utility knife 110b of FIG. 1B. In any event, the actuator 240b may be pivotally attached to the body 205b via an actuator pivot 241b. The hinged link 260b may include a blade carrier link portion 270b hingeably connected to an actuator link portion 280b via a hinged link pivot 261b. The blade carrier link portion 270b may be pivotally attached to the blade carrier 220b via a blade carrier link pivot 216b. The blade carrier link portion 270b may include a hinge stop 271b which may be, for example, configured to limit (or prevent) hinging of the hinged link in a predetermined direction. The actuator link portion 280b may be pivotally attached to the actuator 240b via an actuator link pivot 281b.

The safety utility knife 200b may include a blade 215b replaceably secured to the blade carrier 220b via, for example, pins/holes 217b, 218b. Alternatively, the blade 215b and the blade carrier 220b may be integrated in a single component. In any event, the blade 215b may be constructed as disclosed in commonly assigned U.S. patent application Ser. No. 13/866,074, or the blade 215b may be constructed in accordance with other known designs.

The blade carrier 220b may be pivotally attached to the body 205b via a blade carrier pivot 221b. The blade carrier 220b may include a blade carrier hinge initiating portion 222b. The blade carrier 220b may be biased toward the safety orientation as illustrated in FIG. 2A via a blade carrier biasing spring 230b. The blade carrier biasing spring 230b may be attached to the body 215b via a first blade carrier biasing spring attachment 231b, and may be attached to the blade carrier 220b via a second blade carrier biasing spring attachment 232b.

The safety utility knife 200b may include a lever 210b pivotally attached to the body 215b via a lever pivot 211b. A lever activating portion 212b may cooperate with an actuator portion 242b to pivotally reorient the actuator 220a of FIG. 2A about an actuator pivot 242b, in response to, for example, a user pressing of the lever 210b, to an intermediate position as illustrated in FIG. 2B. More particularly, when a user presses the lever 210b, the lever 210a may rotate the actuator 240b which, in turn, may rotate the blade carrier 220a to the intermediate orientation via the hinged link 260b. Notably, the blade carrier link portion 270b, of the hinged link 260b, is not hinged with respect to the actuator link portion, of the hinged link 260b, while the blade 215a is reoriented from the safety orientation of FIG. 2A to the intermediate orientation of FIG. 2B.

The lever 210b and the actuator 240b may be integrated into a single actuator structure. The actuator 220b and the lever 210b may be biased in a non-actuating orientation, as illustrated in FIG. 2A, via an actuator biasing spring 250b. The actuator biasing spring 250b may be attached to the actuator 240b via a first actuator biasing spring attachment 251b, and may be attached to the body 215b a second actuator biasing spring attachment 252b. The actuator 240b may include an actuator stop 243b configured to limit rotation of the actuator 240b.

With reference to FIG. 2C, a safety utility knife 200c may include a body 205c housing a blade carrier 220c interconnected with an actuator 240c via a hinged linked 260c. The safety utility knife 200c may be similar to, for example, the safety utility knife 110c of FIG. 1C. In any event, the actuator 240c may be pivotally attached to the body 205c via an actuator pivot 241c. The hinged link 260c may include a blade carrier link portion 270c hingeably connected to an actuator link portion 280c via a hinged link pivot 261c. The blade carrier link portion 270c may be pivotally attached to the blade carrier 220c via a blade carrier link pivot 216c. The blade carrier link portion 270c may include a hinge stop 271c which may be, for example, configured to limit (or prevent) hinging of the hinged link in a predetermined direction. The actuator link portion 280c may be pivotally attached to the actuator 240c via an actuator link pivot 281c.

The safety utility knife 200c may include a blade 215c replaceably secured to the blade carrier 220c via, for example, pins/holes 217c, 218c. Alternatively, the blade 215c and the blade carrier 220c may be integrated in a single component. In any event, the blade 215c may be constructed as disclosed in commonly assigned U.S. patent application Ser. No. 13/866,074, or the blade 215c may be constructed in accordance with other known designs.

The blade carrier 220c may be pivotally attached to the body 205c via a blade carrier pivot 221c. The blade carrier 220c may be biased toward the safety orientation as illustrated in FIG. 2A via a blade carrier biasing spring 230c. The blade carrier biasing spring 230c may be attached to the body 215c via a first blade carrier biasing spring attachment 231c, and may be attached to the blade carrier 220c via a second blade carrier biasing spring attachment 232c.

The safety utility knife 200c may include a lever 210c pivotally attached to the body 215c via a lever pivot 211c. The lever 210c may include an lever activating portion 212c that may cooperate with an actuator portion 242c to pivotally reorient the actuator 220c about an actuator pivot 242c.

The blade 215b may be reoriented to a cutting orientation, as illustrated in FIG. 2C, in response to, for example, a user bringing the blade 215b in contact with something (e.g., bringing the blade 215b in contact with a material to be cut). More particularly, when a user presses the lever 210a, the lever 210a may rotate the actuator 240a which, in turn, may rotate the blade carrier 220a to the intermediate orientation, as illustrated in FIG. 2A, via the hinged link 260b. Notably, the blade carrier link portion 270b, of the hinged link 260b, is not hinged with respect to the actuator link portion, of the hinged link 260b, while the blade 215a is reoriented from the safety orientation of FIG. 2A to the intermediate orientation of FIG. 2B. Once the blade 215b is oriented to the intermediate orientation, as illustrated, in FIG. 2B, the blade 215b may be reoriented to a cutting orientation, as illustrated in FIG. 2C, in response to, for example, a user bringing the blade 215b in contact with something (e.g., bringing the blade 215b in contact with a material to be cut). As further illustrated in FIG. 2C, when the blade 215c is oriented to the cutting orientation, as illustrated in FIG. 2C, a blade carrier hinge initiating portion 222c may cause the blade carrier link portion 270c to hinge with respect to the actuator link portion 280c, thereby, allowing the blade 215c to freely return to the safety orientation, as illustrated in FIG. 2A, when the blade 215c is no longer in contact with whatever caused the blade 215c to be oriented to the cutting orientation. Notably, the blade 215c is free to automatically return to the safety orientation irrespective of whether the lever 210c is pressed or not.

The lever 210c and the actuator 240c may be integrated into a single actuator structure. The actuator 220c and the lever 210c may be biased in a non-actuating orientation, as illustrated in FIG. 2A, via an actuator biasing spring 250c. The actuator biasing spring 250c may be attached to the actuator 240c via a first actuator biasing spring attachment 251c, and may be attached to the body 215c a second actuator biasing spring attachment 252c. The actuator 240c may include an actuator stop 243c configured to limit rotation of the actuator 240c.

Turning to FIG. 2D, a safety utility knife 200d may include a body 205d housing a blade carrier 220d interconnected with an actuator 240d via a hinged linked 260d. The safety utility knife 200d may be similar to, for example, the safety utility knife 110a of FIG. 1A. In any event, the actuator 240d may be pivotally attached to the body 205d via an actuator pivot 241d. The hinged link 260d may include a blade carrier link portion 270d hingeably connected to an actuator link portion 280d via a hinged link pivot 261d. The blade carrier link portion 270d may be pivotally attached to the blade carrier 220d via a blade carrier link pivot 216d. The blade carrier link portion 270d may include a hinge stop 271d which may be, for example, configured to limit (or prevent) hinging of the hinged link in a predetermined direction. The actuator link portion 280d may be pivotally attached to the actuator 240d via an actuator link pivot 281d.

The safety utility knife 200d may include a blade 215d replaceably secured to the blade carrier 220d via, for example, pins/holes 217d, 218d. Alternatively, the blade 215d and the blade carrier 220d may be integrated in a single component. In any event, the blade 215d may be constructed as disclosed in commonly assigned U.S. patent application Ser. No. 13/866,074, or the blade 215d may be constructed in accordance with other known designs.

The blade carrier 220d may be pivotally attached to the body 205d via a blade carrier pivot 221d. The blade carrier 220d may be biased toward the safety orientation as illustrated in FIG. 2A via a blade carrier biasing spring 230d. The blade carrier biasing spring 230d may be attached to the body 215d via a first blade carrier biasing spring attachment 231d, and may be attached to the blade carrier 220d via a second blade carrier biasing spring attachment 232d.

The safety utility knife 200d may include a lever 210d pivotally attached to the body 215d via a lever pivot 211d. The lever 210d may include an lever activating portion 212d that may cooperate with an actuator portion 242d to pivotally reorient the actuator 220d about an actuator pivot 242c.

The blade 215c may be automatically reoriented from a cutting orientation, as illustrated in FIG. 2C, when the blade 215d is no longer in contact with whatever caused the blade 215c to be oriented to the cutting orientation. Notably, the blade 215c is free to automatically return to the, safety orientation as illustrated in FIG. 2D, irrespective of whether the lever 210d is pressed or not.

The lever 210d and the actuator 240d may be integrated into a single actuator structure. The actuator 220d and the lever 210d may be biased in a non-actuating orientation, as illustrated in FIG. 2A, via an actuator biasing spring 250d. The actuator biasing spring 250d may be attached to the actuator 240d via a first actuator biasing spring attachment 251d, and may be attached to the body 215d a second actuator biasing spring attachment 252d. The actuator 240d may include an actuator stop 243d configured to limit rotation of the actuator 240d.

With further referenced to FIGS. 2D and 2A, when a user releases the lever 210d, the hinged link 260d of FIG. 2D may be reoriented as illustrated by hinged link 260a of FIG. 2A. Once the hinged link 260d is reoriented as illustrated by hinged link 260a, the user may cycle the safety utility knife 200a, 200b, 200c, 200d as described with regard to FIGS. 2A-2D.

For example, the safety utility knife 200a, 200b, 200c, 200d may include a blade carrier pivotally connected to an actuator via a hinged link, wherein the blade carrier is pivotable between a safety orientation, an intermediate orientation, and a cutting orientation, wherein the actuator is pivotable between a non-actuating orientation and an actuating orientation, and wherein the hinged link includes a blade carrier link portion hingingly connected to an actuator link portion. When the actuator is in the non-actuating orientation and the blade carrier may be in the safety orientation, the blade carrier link portion is not hinged with respect to the actuator link portion. When a user reorients the actuator from the non-actuating orientation to the actuating orientation, the blade carrier may be reoriented from the safety orientation to the intermediate orientation, and the blade carrier link portion is not hinged with respect to the actuator link portion. When the blade carrier is oriented in the intermediate orientation and the user initiates a cutting action, the blade carrier may be reoriented from the intermediate orientation to the cutting orientation and the blade carrier hinges the blade carrier link portion with respect to the actuator link portion. When the blade carrier is oriented in the cutting orientation and the actuator may be oriented in the actuating orientation, and the cutting action is discontinued, the blade carrier link portion is further hinged with respect to the actuator link portion and the blade carrier is reoriented to the safety orientation. When the blade carrier is oriented in the cutting orientation and the actuator is oriented in the non-actuating orientation, and the cutting action is discontinued, the blade carrier link portion may be unhinged with respect to the actuator link portion and the blade carrier is reoriented to the safety orientation.

The safety utility knife may include a blade carrier biasing spring that may bias the blade carrier to the safety orientation. The safety utility knife may include an actuator biasing spring that may bias the actuator to the non-actuating orientation.

As another example, the safety utility knife 200a, 200b, 200c, 200d may include a blade carrier repositionable between a safety orientation, an intermediate orientation, and a cutting orientation. The safety utility knife may also include an actuator that may be repositionable between a non-actuating orientation and an actuating orientation. The safety utility knife may further include a hinged link interconnected between the blade carrier and the actuator. The hinged link may include a blade carrier link portion hingingly connected to an actuator link portion. When the actuator is in the non-actuating orientation and the blade carrier is in the safety orientation, the blade carrier link portion may not be hinged with respect to the actuator link portion.

The safety utility knife may include a blade carrier biasing spring that may bias the blade carrier to the safety orientation. The safety utility knife may include an actuator biasing spring that may bias the actuator to the non-actuating orientation.

When a user reorients the actuator from the non-actuating orientation to the actuating orientation, the blade carrier may be reoriented from the safety orientation to the intermediate orientation, and the blade carrier link portion may not be hinged with respect to the actuator link portion. When the blade carrier is oriented in the intermediate orientation and the user initiates a cutting action, the blade carrier may be reoriented from the intermediate orientation to the cutting orientation and the blade carrier may hinge the blade carrier link portion with respect to the actuator link portion. When the blade carrier is oriented in the cutting orientation and the actuator is oriented in the actuating orientation, and the cutting action is discontinued, the blade carrier link portion may be further hinged with respect to the actuator link portion and the blade carrier may be reoriented to the safety orientation. When the blade carrier is oriented in the cutting orientation and the actuator is oriented in the non-actuating orientation, and the cutting action is discontinued, the blade carrier link portion may be unhinged with respect to the actuator link portion and the blade carrier may be reoriented to the safety orientation.

As yet another example, a safety utility knife 200a, 200b, 200c, 200d may include a blade carrier repositionable between a safety orientation, an intermediate orientation, and a cutting orientation. The safety utility knife may also include a blade carrier biasing spring that may bias the blade carrier to the safety orientation. The safety utility knife may further include an actuator that may be repositionable between a non-actuating orientation and an actuating orientation. The safety utility knife may yet further include an actuator biasing spring that may bias the actuator to the non-actuating orientation. The safety utility knife may also include a hinged link, interconnected between the blade carrier and the actuator, that may include a blade carrier link portion hingingly connected to an actuator link portion. The safety utility knife may include an enclosure, and at least one of: the blade carrier or the actuator, may be pivotally secured to the enclosure. The safety utility knife may further include an internal frame, and at least one of: the blade carrier or the actuator, may be pivotally secured to the internal frame. The safety utility knife may further include a blade replaceably secured to the blade carrier.

The safety utility knife may include a blade carrier biasing spring that may bias the blade carrier to the safety orientation. The safety utility knife may include an actuator biasing spring that may bias the actuator to the non-actuating orientation.

When a user reorients the actuator from the non-actuating orientation to the actuating orientation, the blade carrier may be reoriented from the safety orientation to the intermediate orientation, and the blade carrier link portion may not be hinged with respect to the actuator link portion. When the blade carrier is oriented in the intermediate orientation and the user initiates a cutting action, the blade carrier may be reoriented from the intermediate orientation to the cutting orientation and the blade carrier may hinge the blade carrier link portion with respect to the actuator link portion. When the blade carrier is oriented in the cutting orientation and the actuator is oriented in the actuating orientation, and the cutting action is discontinued, the blade carrier link portion may be further hinged with respect to the actuator link portion and the blade carrier may be reoriented to the safety orientation. When the blade carrier is oriented in the cutting orientation and the actuator is oriented in the non-actuating orientation, and the cutting action is discontinued, the blade carrier link portion may be unhinged with respect to the actuator link portion and the blade carrier may be reoriented to the safety orientation.

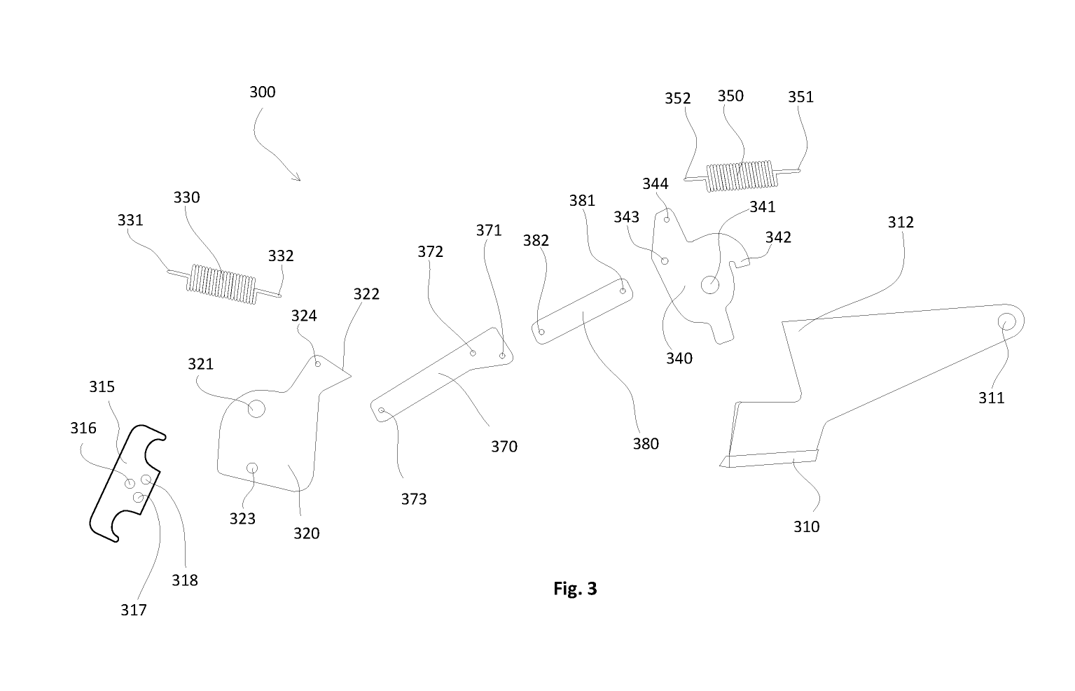

Turning to FIG. 3, an exploded view of various components of a safety utility knife 300 is depicted. The safety utility knife 300 may include a lever 310, a blade 315, a blade carrier 320, a blade carrier biasing spring 330, an actuator 340, an actuator biasing spring 350, a blade carrier link portion 370, and an actuator link portion 380. While any one of, or all of, the lever 310, the blade 315, the blade carrier 320, the blade carrier biasing spring 330, the actuator 340, the actuator biasing spring 350, the blade carrier link portion 370, and the actuator link portion 380 may be secured to a body (e.g., body 115a of FIG. 1A), any one of, or all of, the lever 310, the blade 315, the blade carrier 320, the blade carrier biasing spring 330, the actuator 340, the actuator biasing spring 350, the blade carrier link portion 370, and the actuator link portion 380 may be secured to a frame structure (not shown in FIG. 3) which, in turn, may be secured within a body (e.g., body 115a of FIG. 1A).

The lever 310 may include a lever pivot 311 and an actuator interface portion 312. The blade 315 may include blade attachments 316, 317, 318 to, for example, replaceably secure the blade 315 to the blade carrier 320. The blade carrier 320 may include a blade carrier pivot 321, a blade carrier biasing spring attachment 324, a blade/blade carrier link attachment 323, and a hinge link hinge initiation portion 322. The blade carrier biasing spring 330 may include a first blade carrier biasing spring attachment 331 and a second blade carrier biasing spring attachment 332. The actuator 340 may include an actuator pivot 341, a lever interaction portion 342, and an actuator hinge link portion attachment 343. The actuator biasing spring 350 may include a first actuator biasing spring attachment 351 and a second actuator biasing spring attachment 352. The blade carrier link portion 370 may include a hinge stop 371, an attachment link portion attachment 372, and a blade carrier attachment 373. The actuator link portion 380 may include an actuator attachment 381 and a blade carrier link portion attachment 382.

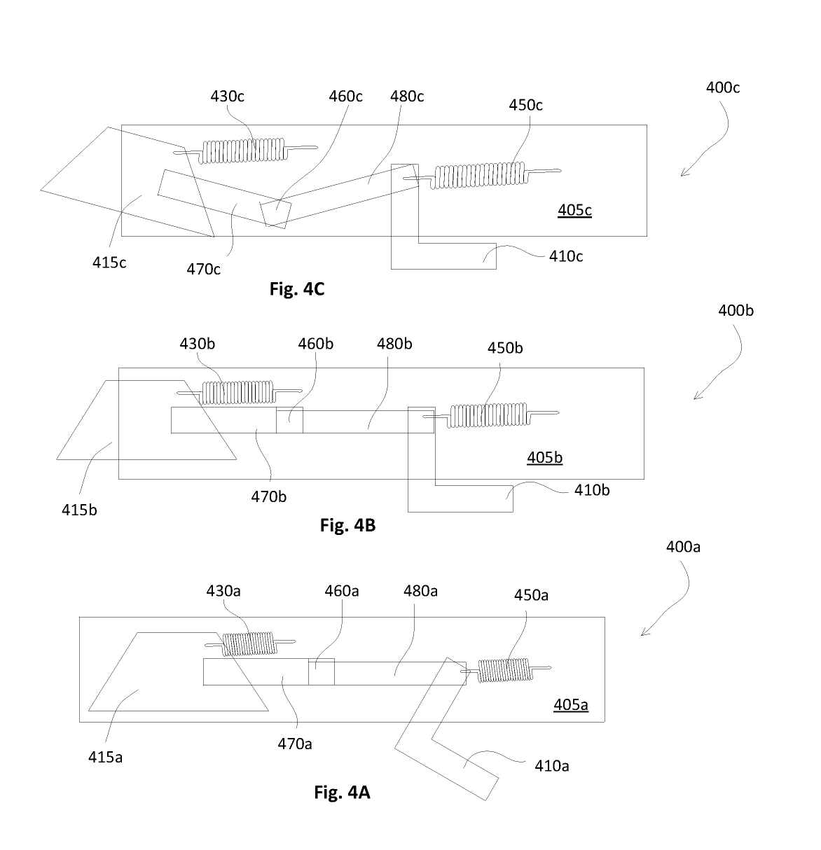

With reference to FIGS. 4A-4C, a safety utility knife 400a, 400b, 400c may include a body 405a, 405b, 405c; an actuator/lever 410a, 410b, 410c; a blade 415a, 415b, 415c; a blade biasing spring 430a, 430b, 430c; an actuator/lever biasing spring 450a, 450b, 450c; and a hinged link 460a, 460b, 460c. The hinged link 460a, 460b, 460c may include a blade link portion 470a, 470b, 470c and an actuator/lever link portion 480a, 480b, 480c. The safety utility knife 400a may be similar to the safety utility knife 100a of FIG. 1A and the safety utility knife 200a of FIG. 2A in function, however, the blade 415a reorients in a linear fashion as opposed to the rotary fashion of blade 115a, 215a. The safety utility knife 400b may be similar to the safety utility knife 100b of FIG. 1B and the safety utility knife 200b of FIG. 2B in function, however, the blade 415b reorients in a linear fashion as opposed to the rotary fashion of blade 115b, 215b. The safety utility knife 400c may be similar to the safety utility knife 100c of FIG. 1C and the safety utility knife 200c of FIG. 2C in function, however, the blade 415c reorients in a linear fashion as opposed to the rotary fashion of blade 115c, 215c.

For example, the safety utility knife 400a, 400b, 400c may include a blade carrier pivotally connected to an actuator via a hinged link, wherein the blade carrier is pivotable between a safety orientation, an intermediate orientation, and a cutting orientation, wherein the actuator/lever is pivotable between a non-actuating orientation and an actuating orientation, and wherein the hinged link includes a blade carrier link portion hingingly connected to an actuator link portion. When the actuator/lever is in the non-actuating orientation and the blade carrier may be in the safety orientation, the blade carrier link portion is not hinged with respect to the actuator link portion. When a user reorients the actuator/lever from the non-actuating orientation to the actuating orientation, the blade carrier may be reoriented from the safety orientation to the intermediate orientation, and the blade carrier link portion is not hinged with respect to the actuator link portion. When the blade carrier is oriented in the intermediate orientation and the user initiates a cutting action, the blade carrier may be reoriented from the intermediate orientation to the cutting orientation and the blade carrier hinges the blade carrier link portion with respect to the actuator link portion. When the blade carrier is oriented in the cutting orientation and the actuator may be oriented in the actuating orientation, and the cutting action is discontinued, the blade carrier link portion is further hinged with respect to the actuator link portion and the blade carrier is reoriented to the safety orientation. When the blade carrier is oriented in the cutting orientation and the actuator/lever is oriented in the non-actuating orientation, and the cutting action is discontinued, the blade carrier link portion may be unhinged with respect to the actuator link portion and the blade carrier is reoriented to the safety orientation.

The safety utility knife may include a blade carrier biasing spring that may bias the blade carrier to the safety orientation. The safety utility knife may include an actuator biasing spring that may bias the actuator/lever to the non-actuating orientation.

As another example, the safety utility knife 400a, 400b, 400c may include a blade carrier repositionable between a safety orientation, an intermediate orientation, and a cutting orientation. The safety utility knife may also include an actuator/lever that may be repositionable between a non-actuating orientation and an actuating orientation. The safety utility knife may further include a hinged link interconnected between the blade carrier and the actuator/lever. The hinged link may include a blade carrier link portion hingingly connected to an actuator link portion. When the actuator/lever is in the non-actuating orientation and the blade carrier is in the safety orientation, the blade carrier link portion may not be hinged with respect to the actuator link portion.

The safety utility knife may include a blade carrier biasing spring that may bias the blade carrier to the safety orientation. The safety utility knife may include an actuator biasing spring that may bias the actuator/lever to the non-actuating orientation.

When a user reorients the actuator/lever from the non-actuating orientation to the actuating orientation, the blade carrier may be reoriented from the safety orientation to the intermediate orientation, and the blade carrier link portion may not be hinged with respect to the actuator link portion. When the blade carrier is oriented in the intermediate orientation and the user initiates a cutting action, the blade carrier may be reoriented from the intermediate orientation to the cutting orientation and the blade carrier may hinge the blade carrier link portion with respect to the actuator link portion. When the blade carrier is oriented in the cutting orientation and the actuator/lever is oriented in the actuating orientation, and the cutting action is discontinued, the blade carrier link portion may be further hinged with respect to the actuator link portion and the blade carrier may be reoriented to the safety orientation. When the blade carrier is oriented in the cutting orientation and the actuator/lever is oriented in the non-actuating orientation, and the cutting action is discontinued, the blade carrier link portion may be unhinged with respect to the actuator link portion and the blade carrier may be reoriented to the safety orientation.

As yet another example, a safety utility knife 400a, 400b, 400c may include a blade carrier repositionable between a safety orientation, an intermediate orientation, and a cutting orientation. The safety utility knife may also include a blade carrier biasing spring that may bias the blade carrier to the safety orientation. The safety utility knife may further include an actuator/lever that may be repositionable between a non-actuating orientation and an actuating orientation. The safety utility knife may yet further include an actuator biasing spring that may bias the actuator/lever to the non-actuating orientation. The safety utility knife may also include a hinged link, interconnected between the blade carrier and the actuator, that may include a blade carrier link portion hingingly connected to an actuator link portion. The safety utility knife may include an enclosure, and at least one of: the blade carrier or the actuator/lever, may be pivotally secured to the enclosure. The safety utility knife may further include an internal frame, and at least one of: the blade carrier or the actuator/lever, may be pivotally secured to the internal frame. The safety utility knife may further include a blade replaceably secured to the blade carrier.

The safety utility knife may include a blade carrier biasing spring that may bias the blade carrier to the safety orientation. The safety utility knife may include an actuator biasing spring that may bias the actuator/lever to the non-actuating orientation.

When a user reorients the actuator/lever from the non-actuating orientation to the actuating orientation, the blade carrier may be reoriented from the safety orientation to the intermediate orientation, and the blade carrier link portion may not be hinged with respect to the actuator link portion. When the blade carrier is oriented in the intermediate orientation and the user initiates a cutting action, the blade carrier may be reoriented from the intermediate orientation to the cutting orientation and the blade carrier may hinge the blade carrier link portion with respect to the actuator link portion. When the blade carrier is oriented in the cutting orientation and the actuator/lever is oriented in the actuating orientation, and the cutting action is discontinued, the blade carrier link portion may be further hinged with respect to the actuator link portion and the blade carrier may be reoriented to the safety orientation. When the blade carrier is oriented in the cutting orientation and the actuator/lever is oriented in the non-actuating orientation, and the cutting action is discontinued, the blade carrier link portion may be unhinged with respect to the actuator link portion and the blade carrier may be reoriented to the safety orientation.

Upon reading this disclosure, those of skill in the art will appreciate still additional alternative structural and functional designs for safety blades for use in utility knife assemblies, utility knife assemblies and methods of manufacturing. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the apparatuses and methods disclosed herein without departing from the spirit and scope defined in the appended claims.

What is claimed is:

1. A safety utility knife, comprising:
a blade carrier pivotally connected to an actuator via a hinged link, wherein the blade carrier is pivotable between a safety orientation, an intermediate orientation, and a cutting orientation, wherein the actuator is pivotable between a non-actuating orientation and an actuating orientation, and wherein the hinged link includes a blade carrier link portion hingingly connected to an actuator link portion;
wherein, when the actuator is in the non-actuating orientation and the blade carrier is in the safety orientation, the blade carrier link portion is not hinged with respect to the actuator link portion;
wherein, when a user reorients the actuator from the non-actuating orientation to the actuating orientation, the blade carrier is reoriented from the safety orientation to the intermediate orientation, and the blade carrier link portion is not hinged with respect to the actuator link portion;
wherein, when the blade carrier is oriented in the intermediate orientation and the user initiates a cutting action, the blade carrier is reoriented from the intermediate orientation to the cutting orientation and the blade carrier hinges the blade carrier link portion with respect to the actuator link portion;
wherein, when the blade carrier is oriented in the cutting orientation and the actuator is oriented in the actuating orientation, and the cutting action is discontinued, the blade carrier link portion is further hinged with respect to the actuator link portion and the blade carrier is reoriented to the safety orientation; and
wherein, when the blade carrier is oriented in the cutting orientation and the actuator is oriented in the non-actuating orientation, and the cutting action is discontinued, the blade carrier link portion is unhinged with respect to the actuator link portion and the blade carrier is reoriented to the safety orientation.

2. The safety utility knife as in claim 1, further comprising:
a blade carrier biasing spring, wherein the blade carrier biasing spring biases the blade carrier to the safety orientation.

3. The safety utility knife as in claim 1, further comprising:
an actuator biasing spring, wherein the actuator biasing spring biases the actuator to the non-actuating orientation.

4. A safety utility knife, comprising:
a blade carrier repositionable between a safety orientation, an intermediate orientation, and a cutting orientation;
an actuator, wherein the actuator is repositionable between a non-actuating orientation and an actuating orientation; and
a hinged link interconnected between the blade carrier and the actuator, wherein the hinged link includes a blade carrier link portion hingingly connected to an actuator link portion.

5. The safety utility knife as in claim 4, further comprising:
a blade carrier biasing spring, wherein the blade carrier biasing spring biases the blade carrier to the safety orientation.

6. The safety utility knife as in claim 4, further comprising:
an actuator biasing spring, wherein the actuator biasing spring biases the actuator to the non-actuating orientation.

7. The safety utility knife as in claim 4, wherein, when the actuator is in the non-actuating orientation and the blade carrier is in the safety orientation, the blade carrier link portion is not hinged with respect to the actuator link portion.

8. The safety utility knife as in claim 4, wherein, when a user reorients the actuator from the non-actuating orientation to the actuating orientation, the blade carrier is reoriented from the safety orientation to the intermediate orientation, and the blade carrier link portion is not hinged with respect to the actuator link portion.

9. The safety utility knife as in claim 8, wherein, when the blade carrier is oriented in the intermediate orientation and the user initiates a cutting action, the blade carrier is reoriented from the intermediate orientation to the cutting orientation and the blade carrier hinges the blade carrier link portion with respect to the actuator link portion.

10. The safety utility knife as in claim 9, wherein, when the blade carrier is oriented in the cutting orientation and the actuator is oriented in the actuating orientation, and the cutting action is discontinued, the blade carrier link portion is further hinged with respect to the actuator link portion and the blade carrier is reoriented to the safety orientation.

11. The safety utility knife as in claim 9, wherein, when the blade carrier is oriented in the cutting orientation and the actuator is oriented in the non-actuating orientation, and the cutting action is discontinued, the blade carrier link portion is unhinged with respect to the actuator link portion and the blade carrier is reoriented to the safety orientation.

12. A safety utility knife, comprising:
a blade carrier repositionable between a safety orientation, an intermediate orientation, and a cutting orientation;
a blade carrier biasing spring, wherein the blade carrier biasing spring biases the blade carrier to the safety orientation;
an actuator, wherein the actuator is repositionable between a non-actuating orientation and an actuating orientation;
an actuator biasing spring, wherein the actuator biasing spring biases the actuator to the non-actuating orientation; and
a hinged link interconnected between the blade carrier and the actuator, wherein the hinged link includes a blade carrier link portion hingingly connected to an actuator link portion.

13. The safety utility knife as in claim 12, wherein, when the actuator is in the non-actuating orientation and the blade carrier is in the safety orientation, the blade carrier link portion is not hinged with respect to the actuator link portion.

14. The safety utility knife as in claim 12, wherein, when a user reorients the actuator from the non-actuating orientation to the actuating orientation, the blade carrier is reoriented from the safety orientation to the intermediate orientation, and the blade carrier link portion is not hinged with respect to the actuator link portion.

15. The safety utility knife as in claim 14, wherein, when the blade carrier is oriented in the intermediate orientation and the user initiates a cutting action, the blade carrier is reoriented from the intermediate orientation to the cutting orientation and the blade carrier hinges the blade carrier link portion with respect to the actuator link portion.

16. The safety utility knife as in claim 15, wherein, when the blade carrier is oriented in the cutting orientation and the actuator is oriented in the actuating orientation, and the cutting action is discontinued, the blade carrier link portion is further hinged with respect to the actuator link portion and the blade carrier is reoriented to the safety orientation.

17. The safety utility knife as in claim 15, wherein, when the blade carrier is oriented in the cutting orientation and the actuator is oriented in the non-actuating orientation, and the cutting action is discontinued, the blade carrier link portion is unhinged with respect to the actuator link portion and the blade carrier is reoriented to the safety orientation.

18. The safety utility knife as in claim 12, further comprising:
an enclosure, wherein at least one of: the blade carrier or the actuator, is pivotally secured to the enclosure.

19. The safety utility knife as in claim 12, further comprising:
an internal frame, wherein at least one of: the blade carrier or the actuator, is pivotally secured to the internal frame.

20. The safety utility knife as in claim 12, further comprising:
a blade replaceably secured to the blade carrier.
